(19) United States
(12) Patent Application Publication
(10) Pub. No.: US 2006/0028613 A1
(43) Pub. Date: Feb. 9, 2006

(54) Polarizing sheet for corrective polarizing plastic lens, method of producing the same, production apparatus therefor, and corrective polarizing plastic lens

(76) Inventor: Shinji Yasuda, Hyogo (JP)

Correspondence Address: RABIN & Berdo, PC, 1101 14TH STREET, NW, SUITE 500, WASHINGTON, DC, 20005, US

(21) Appl. No.: 10/978,040

(22) Filed: Nov. 1, 2004

(30) Foreign Application Priority Data
Aug. 3, 2004 (JP) JP PA2004-227186

(51) Int. Cl. G02C 7/02

(52) U.S. Cl. 351/159

(57) ABSTRACT

A polarizing sheet for a corrective polarizing plastic lens in which the polarizing sheet is formed by appropriate bending of a laminated sheet produced by laminating polycarbonate support layers to both sides of a thin polarizing layer, a method and an apparatus for producing such a polarizing sheet, and a corrective polarizing plastic lens that uses the polarizing sheet. The polarizing sheet comprises an aspheric curved surface in which the degree of curvature varies continuously from the center of the curved surface toward the outer periphery, and is formed by subjecting an intermediate product, formed by a first bending process, to a subsequent second bending process.

### BACKGROUND OF THE INVENTION

1. Field of the Invention

The present invention relates to corrective polarizing plastic lenses used in sunglasses or goggles, and more particularly to a polarizing sheet used in corrective polarizing plastic lenses, a method of producing such a polarizing sheet, a production apparatus used for realizing such a production method, and a corrective polarizing plastic lens that uses the above polarizing sheet.

2. Description of the Related Art

Conventionally, sunglasses and goggles have used a plastic lens with a polarizing sheet, formed by bending a laminated sheet produced by laminating polycarbonate support layers to both sides of a thin polarizing layer.

These types of sunglasses and goggles are used for people who do not require spectacles for vision correction. People who wear spectacles are unable to use these sunglasses and goggles as they provide no vision correction, and must instead use clip-on sunglasses that are mounted on the front surface of their spectacles. When these clip-on sunglasses are not needed they are raised so as not to impede the front surface of the spectacles.

However, these clip-on sunglasses increase the weight and bulk of the spectacles, and have a much inferior appearance to normal sunglasses. Moreover, although their removability provides some convenience, because they are prone to detaching if knocked, they are unsuitable for use in sports such as skiing, ice skating, baseball, or boating.

In order to overcome these problems, sunglasses with fitted corrective polarizing plastic lenses must be used. Conventionally, these corrective polarizing plastic lenses are produced by inserting a film-like polarizing sheet that has been preformed with a spherical surface into a mold, and then injecting a molten plastic resin into the mold so that the main body of the lens and the polarizing sheet are integrated together as a single body (for example, see Japanese Examined Patent Publication No. Sho 61-56090).

However, with these corrective polarizing plastic lenses, because the curved surface of the polarizing sheet is a spherical surface, the lenses can only be used for producing spherical lenses for correcting short sightedness or long sightedness. Production of aspheric lenses for a combination of both long and short sightedness is problematic, and the production of an aspheric corrective polarizing plastic lens with a large degree of curvature is particularly difficult.

### SUMMARY OF THE INVENTION

The present invention takes the above problems into consideration, with an object of providing a polarizing sheet for a corrective polarizing plastic lens that enables the production of an aspheric corrective polarizing plastic lens, a method of producing such a polarizing sheet, a production apparatus used for realizing such a production method, and a corrective polarizing plastic lens that uses the above polarizing sheet.

A polarizing sheet for a corrective polarizing plastic lens according to the present invention is formed by appropriate bending of a laminated sheet produced by laminating polycarbonate support layers to both sides of a thin polarizing layer, and comprises an aspheric curved surface in which the degree of curvature varies continuously from the center of the curved surface toward the outer periphery thereof. By using a polarizing sheet of this construction, aspheric lenses for conditions such as a combination of both long and short sightedness can be produced with comparative ease.

In one embodiment of the above polarizing sheet, the degree of curvature of the curved surface is set so as to gradually increase from the center of the surface toward the outer periphery, and the degree of curvature within a predetermined lower central region of the sheet in a direction orthogonal to the direction of the polarization axis is set to a value that is larger than the degree of curvature within a corresponding upper central region. This embodiment enables a corrective polarizing plastic lens for a combination of both long and short sightedness to be produced with ease.

A method of producing a polarizing sheet according to the present invention is used for producing a polarizing sheet for a corrective polarizing plastic lens in which the polarizing sheet is formed by appropriate bending of a laminated sheet produced by laminating polycarbonate support layers to both sides of a thin polarizing layer, and comprises the steps of: conducting a first bending of the laminated sheet to form an intermediate product in which the degree of curvature of the curved surface is smaller than that of a final product; and conducting a second bending of the intermediate product to form the final product with an aspheric curved surface in which the degree of curvature varies continuously from the center of the curved surface toward the outer periphery thereof.

Using this production method, because the bending process is performed in stages, the level of distortion within the curved surface is less than that observed when the final product is produced by a single bending process. Furthermore, even products comprising a curved surface with a large degree of curvature, which have proved difficult to produce using a single bending process, can be formed with ease. Accordingly, by using a polarizing sheet that has been formed using the above production method, an aspheric corrective polarizing plastic lens comprising a curved surface with a large degree of curvature can be produced.

In a preferred embodiment of the present invention, a sheet with a spherical curved surface is formed during the step of forming the aforementioned intermediate product. Furthermore, in another preferred embodiment of the present invention, a sheet with an aspheric curved surface in which the degree of curvature varies continuously from the center of the sheet toward the outer periphery is formed during the step of forming the aforementioned intermediate product. The final product is then produced by subjecting the thus formed intermediate product to a second bending process, thus forming a product with an aspheric curved surface in which the degree of curvature is larger than that observed in the intermediate product, and varies continuously from the center of the curved surface toward the outer periphery.

A production apparatus for a polarizing sheet according to the present invention is used for producing a polarizing sheet for a corrective polarizing plastic lens in which the polarizing sheet is formed by appropriate bending of a laminated sheet produced by laminating polycarbonate support layers to both sides of a thin polarizing layer, and comprises a molding mechanism for subjecting a preheated laminated sheet to bending to mold a polarizing sheet for a corrective polarizing plastic lens. This molding mechanism comprises a rough molding device for conducting a first bending of the laminated sheet to mold an intermediate product in which the degree of curvature of the curved surface is smaller than that of a final product, and a finishing molding device for conducting a second bending of the intermediate product to mold the final product with an aspheric curved surface in which the degree of curvature varies continuously from the center of the curved surface toward the outer periphery thereof.

When using the production apparatus of the present invention to produce a polarizing sheet for a corrective polarizing plastic lens, the laminated sheet is first preheated, and is then subjected to the bending process using the molding mechanism. In this molding mechanism, first, the rough molding device is used for conducting a first bending of the laminated sheet to mold an intermediate product in which the degree of curvature of the curved surface is smaller than that of the final product. This intermediate product is then transferred to the finishing molding device, and the finishing molding device is used for conducting a second bending of the intermediate product to mold a final product with an aspheric curved surface in which the degree of curvature varies continuously from the center of the curved surface toward the outer periphery thereof.

A corrective polarizing plastic lens according to the present invention is molded by injecting a molten plastic into a mold containing an inserted polarizing sheet of the present invention. If a pair of sunglasses are then prepared by fitting these corrective polarizing plastic lenses into a set of spectacle frames, then the problems associated with clip-on sunglasses, including increased weight and bulk, and inferior appearance when compared with normal sunglasses, can be effectively resolved. Furthermore, because these sunglasses are not prone to detaching if knocked, unlike clip-on sunglasses they are suitable for use in sports such as skiing, ice skating, baseball, or boating.

### BRIEF DESCRIPTION OF THE DRAWINGS

FIG. 1 is a plan view of a polarizing sheet according to an embodiment of the present invention;

FIG. 2 is a horizontal cross-sectional view of the polarizing sheet shown in FIG. 1;

FIG. 3 is a vertical cross-sectional view of the polarizing sheet shown in FIG. 1;

FIG. 4 is a plan view of a polarizing sheet according to another embodiment of the present invention;

FIG. 5 is a horizontal cross-sectional view of the polarizing sheet shown in FIG. 4;

FIG. 6 is a vertical cross-sectional view of the polarizing sheet shown in FIG. 4;

FIG. 7 is a horizontal cross-sectional view of another embodiment of an intermediate product;

FIG. 8 is a cross-sectional view showing the laminated structure of a laminated sheet;

FIG. 9 is a series of cross-sectional views showing a production apparatus for a polarizing sheet according to an embodiment of the present invention, showing both the structure of the apparatus and the production sequence;

FIG. 10 is a plan view showing the positioning of guide pins provided on the lower mold of a rough molding device;

FIG. 11 is a plan view of the underside of the upper mold of a rough molding device, showing the pressure surface; and

FIG. 12 is a cross-sectional view of a corrective polarizing plastic lens.

### DETAILED DESCRIPTION OF THE PREFERRED EMBODIMENTS

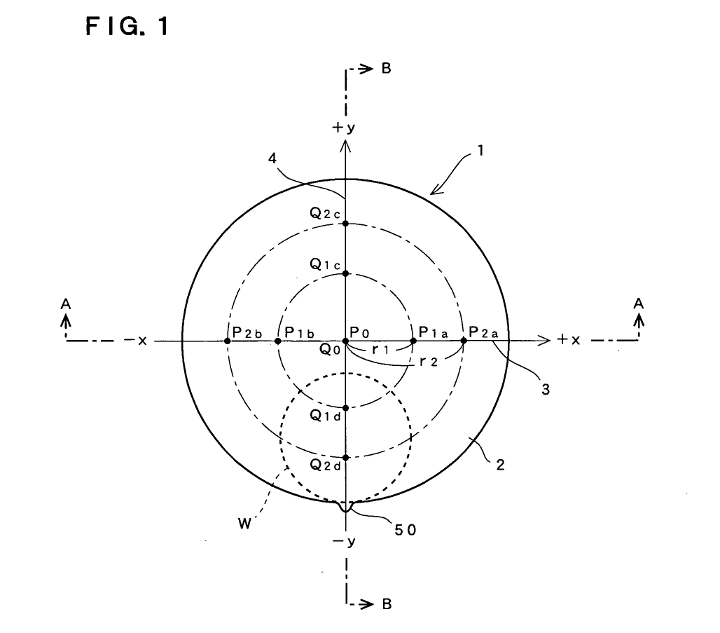

FIG. 1 through FIG. 3 show the external appearance of a polarizing sheet for a corrective polarizing plastic lens (hereafter referred to as simply a “polarizing sheet”) 1 according to one embodiment of the present invention.

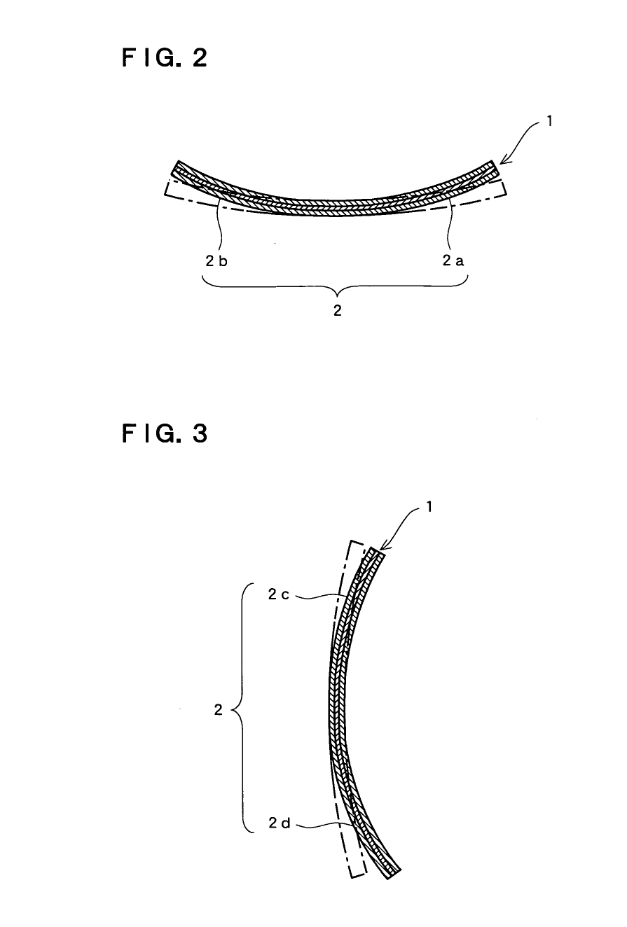

The polarizing sheet 1 shown in the drawings is a film-like material which is formed by subjecting an intermediate product, produced by a first bending process, to a second bending process. When viewed in plan view, the sheet is a circular shape, and comprises a curved surface 2 in which the lower surface is concave and the upper surface is convex. This curved surface 2 is an aspheric curved surface in which the degree of curvature varies continuously from the center of the curved surface toward the outer periphery, and this degree of curvature is set so as to gradually increase from the center of the sheet toward the outer periphery. In FIG. 2 and FIG. 3, the dashed lines show an imaginary spherical curved surface for comparison with the aspheric curved surface 2.

Within the curved surface 2 of this embodiment, along the direction (the vertical direction in FIG. 1) that lies orthogonal to the direction of the polarization axis (the horizontal direction in FIG. 1), the degree of curvature within a predetermined lower central region W is set to a value that is larger than the degree of curvature within a corresponding upper central region. If the direction of the polarization axis across the curved surface 2 is deemed the x axis 3, and the direction orthogonal to this polarization axis is deemed the y axis 4, then the degree of curvature of the curved surface 2a in a positive direction (+x) along the x axis 3, the degree of curvature of the curved surface 2b in the corresponding negative direction (−x), and the degree of curvature of the curved surface 2c in a positive direction (+y) along the y axis 4 are equal, but the degree of curvature of the curved surface 2d in a negative direction (−y) along the y axis 4 is greater than that of the other curved surfaces 2a, 2b, and 2c.

In FIG. 1, the reference numeral 50 represents a tab used for supporting and positioning the sheet during the bending process and during injection molding to produce the lens.

The degree of curvature of the curved surface 2 of the polarizing sheet 1 is determined in accordance with the desired shape for the curved surface of the target corrective polarizing plastic lens. For example, focusing on a plurality of points on the curved surfaces 2a to 2d that extend along the x axis 3 and the y axis 4, the degree of curvature for the curved surface 2a that extends in a positive direction (+x) along the x axis 3 is set to 8.25R at the center point P₀, 8.75R at a point P₁ₐ separated from the point P₀ by a distance r₁, and 9.25R at a point P₂ₐ separated from the point P₀ by a distance r₂ (wherein, r₁<r₂) respectively. Similarly, the degree of curvature for the curved surface 2b that extends in the corresponding negative direction (−x) is set to 8.75R at a point P_{1b} separated from the point P₀ by the distance r₁, and 9.25R at a point P_{2b} separated from the point P₀ by the distance r₂ respectively.

The degree of curvature for the curved surface 2c that extends in a positive direction (+y) along the y axis 4 is set to 8.25R at the center point Q₀, 8.75R at a point Q_{1c} separated from the point Q₀ by the distance r₁, and 9.25R at a point Q_{2c} separated from the point Q₀ by the distance r₂ respectively. In contrast, the degree of curvature for the curved surface 2d that extends in the corresponding negative direction (−y) is set to 9.5R at a point Q_{1d} separated from the point Q₀ by the distance r₁, and 10.5R at a point Q_{2d} separated from the point Q₀ by the distance r₂ respectively.

In this description, the numerical value (for example, 8.25R) used to represent the magnitude of the degree of curvature of the curved surface is inversely proportional to the magnitude of the radius of curvature, so that a larger degree of curvature value represents a more sharply curved surface.

In FIG. 1, the numerical value that represents the magnitude of the degree of curvature of the curved surface varies continuously, and increases gradually from the center of the curved surface toward the outer periphery, even for points that do not lie on either of the axes 3 or 4.

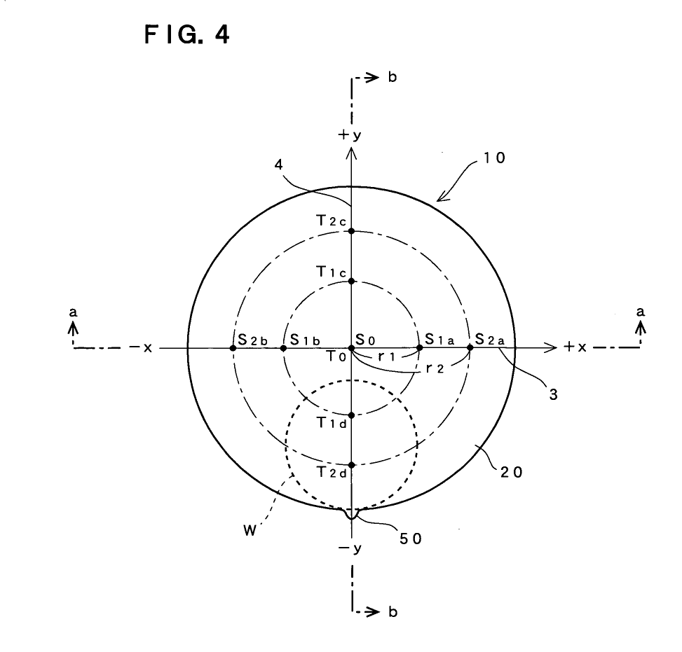

A polarizing sheet 10 of another embodiment shown in FIG. 4 to FIG. 6 also comprises an aspheric curved surface 20 in which the degree of curvature varies continuously, and increases gradually from the center of the curved surface toward the outer periphery. Within the curved surface 20, along the direction (the vertical direction in FIG. 4) that lies orthogonal to the direction of the polarization axis (the horizontal direction in FIG. 4), the degree of curvature within a predetermined lower central region W is set to a value that is larger than the degree of curvature within a corresponding upper central region. However, the degree of curvature values for each of the curved surfaces 20a to 20d that extend along the x axis 3 and the y axis 4 are set to smaller values than the degree of curvature values for the corresponding curved surfaces 2a to 2d from the embodiment shown in FIG. 1 to FIG. 3.

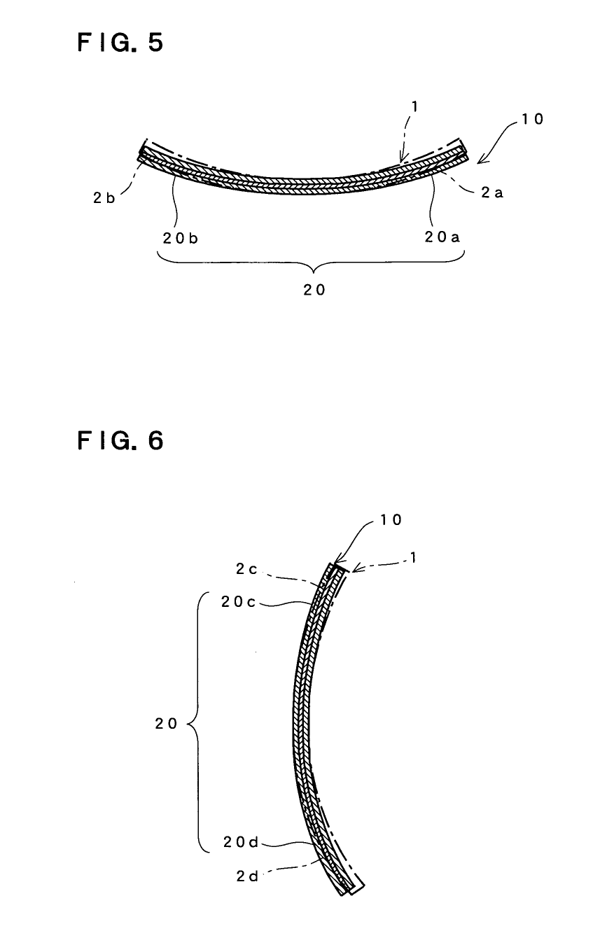

This embodiment can be used either as a final product, or as an intermediate product for producing the embodiment shown in FIG. 1 to FIG. 3. If used as an intermediate product, then the structure is subjected to a subsequent second bending to effect a deeper bending, as shown by the dashed lines in FIG. 5 and FIG. 6.

In the embodiment shown in FIG. 4 to FIG. 6, the degree of curvature for the curved surface 20a that extends in a positive direction (+x) along the x axis 3 is set to 6.25R at the center point S₀, 6.75R at a point S₁ₐ separated from the point S₀ by a distance r₁, and 7.25R at a point S₂ₐ separated from the point S₀ by a distance r₂ (wherein, r₁<r₂) respectively. Similarly, the degree of curvature for the curved surface 20b that extends in the corresponding negative direction (−x) is set to 6.75R at a point S_{1b} separated from the point S₀ by the distance r₁, and 7.25R at a point S_{2b} separated from the point S₀ by the distance r₂ respectively.

The degree of curvature for the curved surface 20c that extends in a positive direction (+y) along the y axis 4 is set to 6.25R at the center point T₀, 6.75R at a point T_{1c} separated from the point T₀ by the distance r₁, and 7.25R at a point T_{2c} separated from the point T₀ by the distance r₂ respectively. In contrast, the degree of curvature for the curved surface 20d that extends in the corresponding negative direction (−y) is set to 7.5R at a point T_{1d} separated from the point T₀ by the distance r₁, and 8.0R at a point T_{2d} separated from the point T₀ by the distance r₂ respectively.

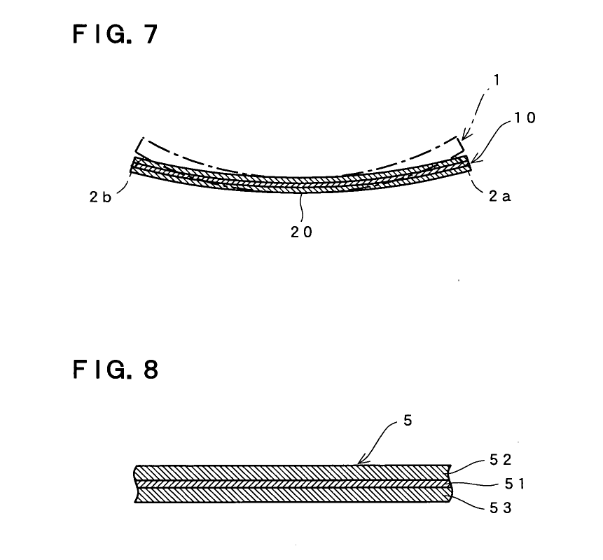

The intermediate product formed in the first bending process need not necessarily comprise an aspheric curved surface such as that shown in the embodiment shown in FIG. 4 to FIG. 6, where the degree of curvature of the curved surface varies continuously from the center of the curved surface toward the outer periphery. As shown in FIG. 7, a spherical curved surface in which the degree of curvature is uniform at all points (such as a product comprising a curved surface in which the degree of curvature along the direction of the polarization axis and along the direction orthogonal to this polarization axis is 6R) is also possible.

The polarizing sheet 1 described above is formed by bending a laminated sheet 5 shown in FIG. 8. This laminated sheet 5 comprises a thin polarizing layer 51 with polycarbonate support layers 52 and 53 laminated on both sides thereof. The thin polarizing layer 51 is a structure in which a dichroic dye is oriented on top of a polymer film such as polyvinyl alcohol.

In this embodiment, in order to produce a polarizing sheet 1 through bending of the aforementioned laminated sheet 5, first the laminated sheet 5 is subjected to a first bending process, thus forming the polarizing sheet 10 shown in FIG. 4 to FIG. 6, comprising an aspheric curved surface 20 with a smaller degree of curvature than the final product, as an intermediate product. Subsequently, this intermediate product is subjected to a second bending process, thus forming the polarizing sheet 1 shown in FIG. 1 to FIG. 3, comprising the aforementioned aspheric curved surface 2, as the final product. Dividing the bending of the laminated sheet 5 into first and second bending processes in this manner enables the target product to be obtained without having to apply the type of unreasonable force that is required if the molding is completed in a single bending process. As a result, the characteristics associated with distortion can be improved.

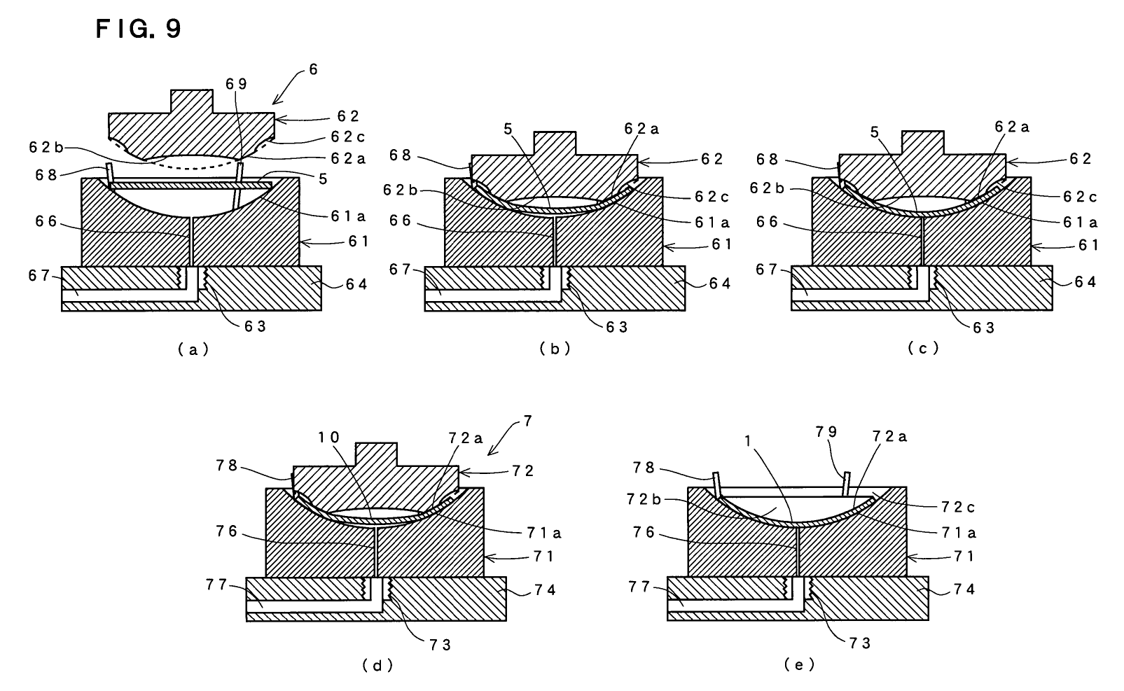

FIGS. 9(a) to (e) show a polarizing sheet production apparatus and the production sequence used for producing the target polarizing sheet 1 by conducting the aforementioned first and second bending processes.

FIGS. 9(a), (b), and (c) show the first bending process using a rough molding device 6, whereas FIGS. 9(d) and (e) show the second bending process using a finishing molding device 7.

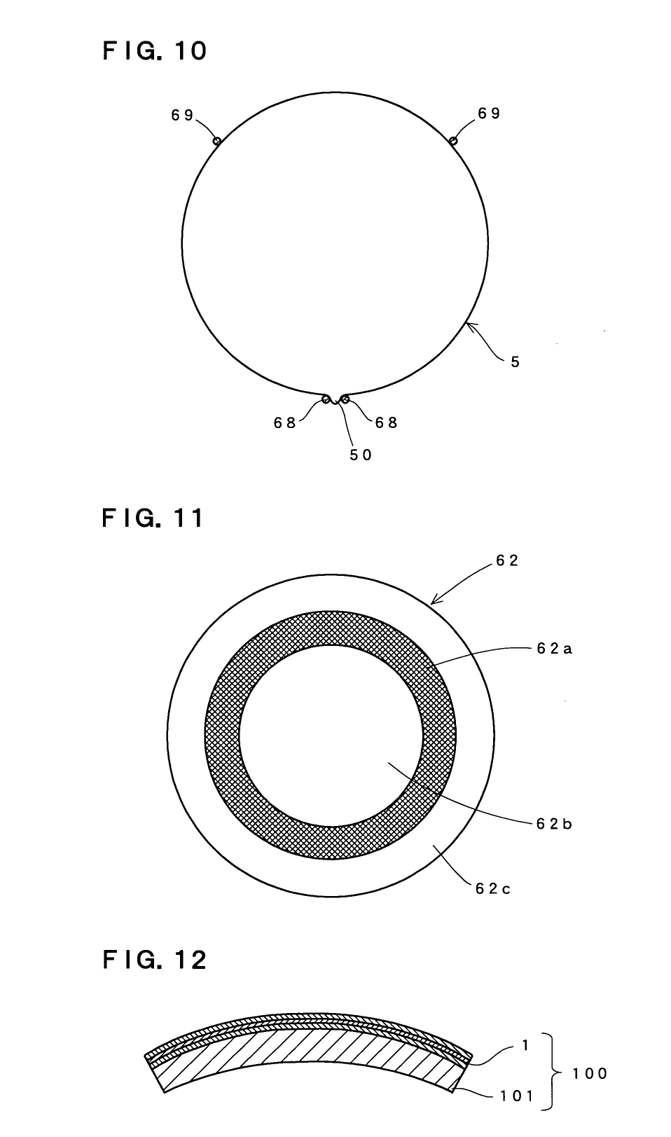

In the rough molding device 6 shown in FIGS. 9(a), (b), and (c), the reference numeral 61 represents a lower mold comprising a concave shaped mold cavity 61a that corresponds with the curved surface 20 of the polarizing sheet 10 of the aforementioned intermediate product. As shown in FIG. 10, the mold cavity 61a of the lower mold 61 incorporates a total of four positioning guide pins 68 and 69, positioned at 120 degree intervals around the periphery. The guide pins 68 and 69 support the outer edge of the laminated sheet 5 via a three-point suspension, and the pair of guide pins 68 hold the outer edge of the laminated sheet 5 by engaging with the aforementioned tab 50.

The reference numeral 62 represents an upper mold for pressing the outer peripheral sections of the laminated sheet 5 down into the mold cavity 61a of the lower mold 61, and comprises a ring-shaped pressure surface 62a that follows the outer peripheral sections of the mold cavity 61a of the lower mold 61. This upper mold 62 is formed from a soft material such as a silicon resin, rubber, elastomer, or fluororesin, and displays favorable heat resistance, flexibility, and elasticity.

The lower mold 61 is supported on top of a support base 64, and is heated by a heater 63 that is integrated within the support base 64. The lower mold 61 and the support base 64 comprise suction apertures 66 and 67 respectively, which connect through to the inside of the mold cavity 61a of the lower mold 61, and are used for applying a suction force to the article undergoing molding. The suction apertures 66 and 67 are interconnected, and the suction aperture 67 is connected to a suction mechanism not shown in the drawings.

The shape of the upper mold 62 corresponds with the shape of the polarizing sheet 10, and as shown in FIG. 11, is a circular shape when viewed from underneath. The shape of the pressure surface 62a follows the outer shape of the upper mold 62. The size of the pressure surface 62a is set so that the outer edge is positioned inside the tab 50. The upper mold 62 and the pressure surface 62a are, of course, not restricted to the shapes described in this embodiment.

The central section of the underside of the upper mold 62 that is encircled by the pressure surface 62a, and the outer periphery of the upper mold 62 that surrounds the pressure surface 62a both have a concave shape so as not to contact the laminated sheet 5 during the bending process. There are no particular restrictions on the depth or shape of these concave sections 62b and 62c, provided that they do not contact the laminated sheet 5 during bending.

The finishing molding device 7 shown in FIGS. 9(d) and (e) comprises a lower mold 71 with a mold cavity 71a of a concave shape that corresponds with the curved surface 2 of the polarizing sheet 1 as the final product, and an upper mold 72 with a ring-shaped convex pressure surface 72a that follows the outer peripheral sections of the mold cavity 71a. In the drawings, the reference numerals 78 and 79 represent positioning guide pins, which have a similar structure to the guide pins 68 and 69 of the rough molding device 6. The structure of the upper mold 72 is identical with that of the upper mold 62 of the rough molding device 6, and as such, no description is given here.

The lower mold 71 is supported on top of a support base 74, and is heated by a heater 73 that is integrated within the support base 74. The lower mold 71 and the support base 74 comprise suction apertures 76 and 77 respectively, which connect through to the inside of the mold cavity 71a of the lower mold 71, and are used for applying a suction force to the article undergoing molding. The suction apertures 76 and 77 are interconnected, and the suction aperture 77 is connected to a suction mechanism not shown in the drawings.

In order to use the rough molding device 6 shown in FIGS. 9(a), (b), and (c) for molding a polarizing sheet 10 that functions as an intermediate product, the lower mold 61 is first heated to a predetermined temperature by the heater 63, and a laminated sheet 5 is then set in a horizontal position on top of the mold cavity 61a of the lower mold 61 (FIG. 9(a)). The laminated sheet 5 is typically preheated by exposure to a hot air stream for a predetermined period, in order to facilitate the bending process.

The preheating and subsequent heating of the laminated sheet 5 may be conducted solely in a hot air stream, and in such cases, the heater 63 need not be provided within the support base 64. Heating the laminated sheet 5 using only a hot air stream can be achieved by setting the temperature of the atmosphere surrounding the laminated sheet 5 to a predetermined temperature.

Subsequently, the suction mechanism, which is not shown in the drawings, is activated, and a suction force is applied to the inside of the mold cavity 61a of the lower mold 61, while the upper mold 62 is lowered (FIG. 9(b)). At this point, the ring-shaped pressure surface 62a of the upper mold 62 contacts the laminated sheet 5, pressing the outer peripheral sections of the laminated sheet 5 against the lower mold 61. In contrast, the concave sections 62b and 62c in the center and at the outer periphery of the upper mold 62 respectively do not contact the laminated sheet 5. The laminated sheet 5 undergoes thermal deformation under the influence of the suction force applied to the inside of the mold cavity 61a of the lower mold 61, and is suctioned against the mold cavity 61a of the lower mold 61 (FIG. 9(c)).

Accordingly, the upper mold 62 applies no pressure to the central section of the laminated sheet 5, whereas the outer peripheral sections of the laminated sheet 5 that lie inside the tab 50 are pressed downward by the ring-shaped pressure surface 62a. As a result, wrinkling does not develop at the tab section 50, meaning gaps caused by such wrinkling can be prevented. The absence of gaps means that air cannot penetrate into the region between the laminated sheet 5 and the mold cavity 61a of the lower mold 61, thus allowing a favorable suction force to be applied to the laminated sheet 5, and enabling a more favorable bending process to be conducted.

Subsequently, the upper mold 62 is raised while the suction force is still being applied to the inside of the mold cavity 61a, and the molded product is subjected to a hot air stream for a predetermined period to maintain the shape of the product. Ejecting this molded product from the mold cavity 61a yields the polarizing sheet 10 that functions as an intermediate product.

This intermediate product polarizing sheet 10 is then set, with the correct orientation, inside the mold cavity 71a of the lower mold 71 of the finishing molding device 7, which has been heated using the heater 73. A suction force is then applied to the inside of the mold cavity 71a while the upper mold 72 is lowered, thereby bending the intermediate product between the pressure surface 72a of the upper mold 72 and the mold cavity 71a of the lower mold 71 (FIG. 9(d)). Subsequently, the upper mold 72 is raised while the suction force is still being applied to the inside of the mold cavity 71a, and the lower mold 71 is then subjected to a hot air stream for a predetermined period to maintain the shape of the product (FIG. 9(e)). This completes the production of the polarizing sheet 1 that functions as the final product, which is subsequently ejected from the lower mold 71.

FIG. 12 shows a corrective polarizing plastic lens 100 produced using a polarizing sheet 1 prepared via the molding process described above.

This corrective polarizing plastic lens 100 is an integrated combination of a lens main body 101 and the polarizing sheet 1, and is produced by injecting molten plastic into the molding die of an injection molding device (not shown in the drawing) containing the inserted polarizing sheet 1.

A pair of corrective sunglasses can then be produced by fitting corrective polarizing plastic lenses 100 produced in this manner into a set of spectacle frames.

1. A polarizing sheet for a corrective polarizing plastic lens, the sheet being formed by appropriate bending of a laminated sheet produced by laminating polycarbonate support layers to both sides of a thin polarizing layer, comprising an aspheric curved surface in which the degree of curvature varies continuously from the center of the curved surface toward the outer periphery thereof.

2. The polarizing sheet for a corrective polarizing plastic lens according to claim 1, wherein
the degree of curvature of the curved surface is set so as to gradually increase from the center of the surface toward the outer periphery, and the degree of curvature within a predetermined lower central region of the sheet in a direction orthogonal to the direction of the polarization axis is set to a value that is larger than the degree of curvature within a corresponding upper central region.

3. A method of producing a polarizing sheet for a corrective polarizing plastic lens in which the polarizing sheet is formed by appropriate bending of a laminated sheet produced by laminating polycarbonate support layers to both sides of a thin polarizing layer, the method comprising the steps of:
conducting a first bending of the laminated sheet to form an intermediate product in which the degree of curvature of the curved surface is smaller than that of a final product; and
conducting a second bending of the intermediate product to form the final product with an aspheric curved surface in which the degree of curvature varies continuously from the center of the curved surface toward the outer periphery thereof.

4. The method of producing a polarizing sheet for a corrective polarizing plastic lens according to claim 3, wherein
a sheet with a spherical curved surface is formed during the step of forming the intermediate product.

5. The method of producing a polarizing sheet for a corrective polarizing plastic lens according to claim 3, wherein
a sheet with an aspheric curved surface in which the degree of curvature varies continuously from the center of the curved surface toward the outer periphery thereof is formed during the step of forming the intermediate product.

6. A production apparatus for a polarizing sheet for a corrective polarizing plastic lens in which the polarizing sheet is formed by appropriate bending of a laminated sheet produced by laminating polycarbonate support layers to both sides of a thin polarizing layer,
the apparatus comprising a molding mechanism for subjecting a preheated laminated sheet to bending to mold a polarizing sheet for a corrective polarizing plastic lens,
the molding mechanism comprising a rough molding device for conducting a first bending of the laminated sheet to mold an intermediate product in which the degree of curvature of the curved surface is smaller than that of a final product, and a finishing molding device for conducting a second bending of the intermediate product to mold the final product with an aspheric curved surface in which the degree of curvature varies continuously from the center of the curved surface toward the outer periphery thereof.

7. A corrective polarizing plastic lens molded by injecting a molten plastic into a mold containing an inserted polarizing sheet according to claim 1.

8. A corrective polarizing plastic lens molded by injecting a molten plastic into a mold containing an inserted polarizing sheet according to claim 2.
